(19) United States
(12) Patent Application Publication
(10) Pub. No.: US 2013/0263505 A1
(43) Pub. Date: Oct. 10, 2013

(54) Piling Pots

(71) Applicant: Robert Iesals, Bayville, NJ (US)

(72) Inventor: Robert Iesals, Bayville, NJ (US)

(21) Appl. No.: 13/440,518

(22) Filed: Apr. 5, 2012

(51) Int. Cl. A01G 9/02

(52) U.S. Cl. 47/65.7

(57) ABSTRACT

The invention provides a flower pot configured specifically to be easily mounted atop a waterfront piling to increase attractiveness of the waterfront experience and to prevent nautical birds from landing and soiling the pilings.

### FIELD OF THE INVENTION

The present invention relates generally to the field of pots and more specifically relates to a flower pot configured specifically to be easily mounted atop a waterfront piling.

### BACKGROUND OF THE INVENTION

A flower pot or plant pot is a container (such as a pot) in which flowers and other plants are cultivated. Historically, and still to a significant extent today, they are made from terra cotta. Flower pots are now often made from plastic, wood, stone, or sometimes biodegradable material. Often there are holes in the bottom, to allow excess water to flow out, sometimes to a saucer that is placed under the flower pot. The plant may use this water with its root system, as needed. Recently, some flower pots have been made with an automatic watering system, using a reservoir.

Various attempts have been made to solve problems found in flower pot art to provide a flower pot suitable for mounting on a piling or other columnar structure. Among these are:

U.S. Pat. No. 6,715,232 to Frank W. Rice describes a flower pot having an internal channel extending upward from the center of the bottom of the pot, wherein the channel is capable of being mounted on a piling or other columnar structure.

U.S. Pub. No. 2007/0220809 to Ron Serio describes a flower pot and method wherein the flower pot has an indentation to accommodate an internal post support.

None of the above inventions and patents, taken either singly or in combination, is seen to describe the present invention as claimed Thus, a need exists for a reliable flower pot configured specifically to be easily mounted atop a waterfront piling and to avoid the abovementioned problems.

### BRIEF SUMMARY OF THE INVENTION

In view of the foregoing disadvantages inherent in the known flower pot device art, the present invention provides novel Piling Pots. The general purpose of the present invention, which will be described subsequently in greater detail, is to provide a flower pot configured specifically to be easily mounted atop a waterfront piling and to provide waterfront property owners attractive decorative accents for pilings, as well as an attractive alternative to bird spikes traditionally used to prevent birds from perching on and soiling the pilings and to avoid the above-mentioned problems. The features of the invention which are believed to be novel are particularly pointed out and distinctly claimed in the concluding portion of the specification. These and other features, aspects, and advantages of the present invention will become better understood with reference to the following drawings and detailed description

### BRIEF DESCRIPTION OF THE DRAWINGS

The figures which accompany the written portion of this specification illustrate embodiments and methods of use for the present invention, Piling Pots, constructed and operative according to the teachings of the present invention.

FIG. 1 shows a perspective view illustrating a Piling Pots according to an embodiment of the present invention showing an exploded view the show the individual components of the present invention.

FIG. 2 is a perspective front view illustrating the Piling Pots according to an embodiment of the present invention showing the pot containing a plant mounted onto the top of a piling.

FIG. 3 is a perspective view illustrating the Piling Pots in an ‘in-use’ condition according to an embodiment of the present invention, showing a pair of pots containing plants mounted onto a pair of pilings.

The various embodiments of the present invention will hereinafter be described in conjunction with the appended drawings.

### DETAILED DESCRIPTION OF THE INVENTION

As discussed above, embodiments of the present invention relate to a flower pot device and more particularly to Piling Pots configured specifically to be easily mounted atop a waterfront piling. The refuge and beauty of waterfront living are enjoyed by many. Whether one lives on a man-made or natural lake, beside a flowing river, or at an oceanfront resort, living in close proximity to water is for many the equivalent of being on an endless vacation. For those who enjoy outdoor activities such as fishing, sailing or swimming, waterfront living simply can't be beat. Further, many senior citizens and retirees move to waterfront areas in their later years, simply because water provides a sense of calm and tranquility. After all, what may be more peaceful that watching the sun rise and set everyday over a crystal clear lake or grassy marsh? For those who live in waterfront properties, retaining walls or “bulkheads” against the shoreline are often a necessity as a means of protecting property from storm damage and erosion. A marine bulkhead is commonly defined as a vertical shoreline stabilization structure configured primarily to retain soil. Constructed from a variety of materials, bulkheads may be manufactured of concrete, wood, steel and even vinyl. Typically, bulkheads are supported by vertical columns or “pilings” driven into the ground to provide structural support.

As with the bulkhead itself, pilings may be manufactured from a wide range of material's including wood, steel and concrete, to name a few. Because of a bulkhead's close proximity to the water, the vertical pilings which support these walls are often a natural resting place for nautical birds. While there is little dispute that the image of a pelican perched atop a piling may be a lovely picture, the mess left behind by these animals may quickly detract from their beauty. Simply stated, birds perched on pilings often leave droppings on the surface of the piling, rendering the piling both unsightly and unsanitary. Not limited to the pilings, the entire surrounding area including the bulkhead and dock are subject to being sullied by bird droppings.

As may be imagined, attempting to tie a small fishing boat to a piling, only to discover that the piling is covered in bird droppings may be less than pleasant. Keeping pilings and bulkheads clean of these droppings may be a time consuming, tedious and seemingly endless task. Many attempt to solve this problem by installing bird spikes atop bulkhead pilings. As the name implies, bird spikes are sharpened plastic or metal spikes, configured in clusters and designed to be mounted atop pilings, thus preventing birds from landing and perching on the piling. Although these spikes do indeed prevent birds from landing on the pilings, their harsh, utilitarian design may detract from a beautiful seascape and thus many waterfront homeowners simply choose not to use them.

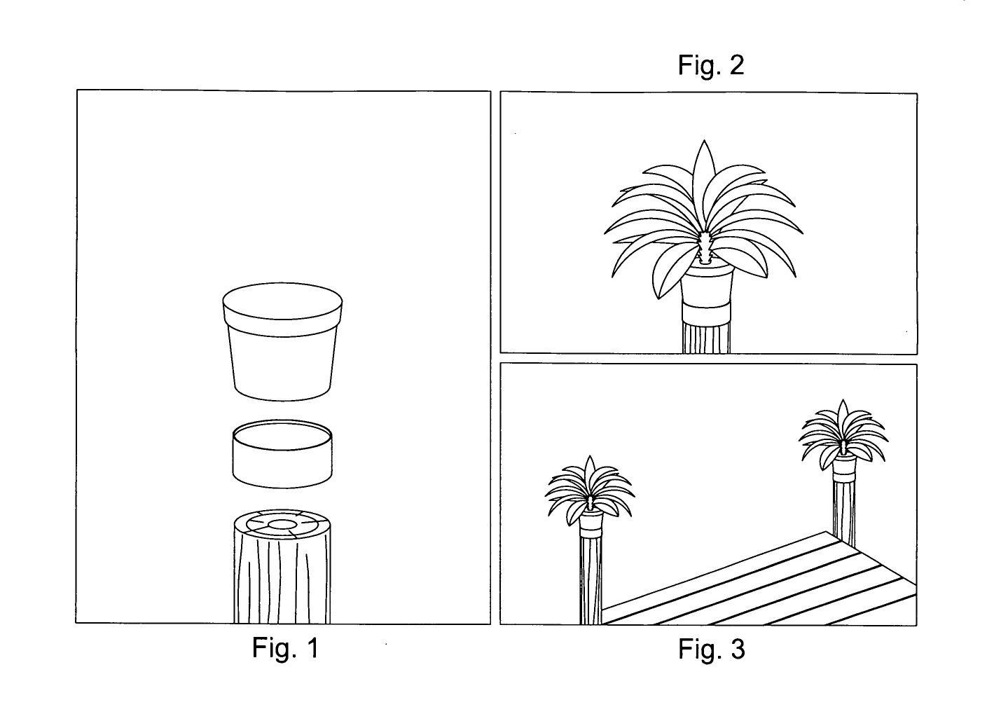

Referring now to the drawings FIGS. 1-3, the Piling Pot comprising a novel product offering consumers a practical solution to the aforementioned challenges. As the name implies, the Piling Pot comprises a specially designed flower pot configured expressly to be easily mounted atop a piling. Thus when filled with plants or flowers, the Piling Pot may prevent birds from perching atop the piling while also providing a unique decorative accent for the bulkhead. Manufactured primarily of a heavy duty and weather resistant plastic material, the Piling Pot may be similar in appearance to a traditional flower pot and may be an open, cylindrical shaped receptacle with the base of the unit measuring slightly smaller in diameter than the open mouth of the pot. The Piling Pot may measure approximately 12 inches in depth, with pots featuring a diameter of 8 inches and 10 inches also offered in the line.

For practical purposes, a circular shaped drainage hole may be centrally positioned on the base of the pot. Included for sale with the Piling Pot may be a cylindrical shaped sleeve designed to be mounted directly to the bulkhead as well as serving as a base tray for the flower pot itself. This sleeve may be secured to the top of the piling via two threaded screws driven through the center of the unit.

The top of this sleeve may culminate in an overflow tray for the flower pot, with a threaded fitting running the perimeter of the interior of the tray and corresponding to a threaded fitting located on the base of the Piling Pot itself. As an added design feature the Piling Pot may be manufactured boasting solar powered lights incorporated into its design which are automatically activated during the evening hours. The Piling Pot may be produced in a range of vibrant colors and patterns, as well as natural bisque or neutral hues.

To add color, or decorative or holiday accents, and unique style without replacing the pots, a decorative sleeve is applied around the outside of the pot. A decorative sleeve can be sold separately and feature different colors, textures and designs. Seasonal colors as well as holiday decorations can be included in the line of decorative sleeves.

Installation and use of the Piling Pot may be very simple and straight forward. The user may simply purchase one or more pots in Sizes appropriate to accommodate their waterfront pilings. According to easily followed package instructions, the user may then mount the Piling Pot in place by first installing the support sleeve over the top of the piling. Sliding the cylindrical sleeve over the piling, the user may make sure to position the unit so that the base of the sleeve rested flush against the top of the piling and the sides of the sleeve extended several inches over the sides of the piling, securing the unit in place via the two threaded screws which run through the center of the unit.

Next, the user may simply screw the actual flower pot to the installed support, via the corresponding threaded fittings located on the top of the base tray and bottom of the Piling Pot, respectively. Properly installed, the Piling Pot may rest securely atop the piling with the user then filling the pot with soil and their favorite flowers or plants. The Piling Pot may be left in place as long as desired, with the user periodically watering and caring for flowers and plants planted within as needed.

The Piling Pot is an innovative product invention which may offer consumers a number of significant benefits and advantages. Foremost, the Piling Pot may provide waterfront dwellers a sensible way in which to prevent birds from perching on bulkhead support pilings. An easily installed flower pot which encompasses the top of the piling completely, the Piling Pot may provide an effective deterrent for nautical birds, preventing these creatures from resting on and sullying the pilings and bulkhead with their unsightly droppings. An aesthetically pleasing alternative to the utilitarian bird spikes traditionally used to prevent birds from perching or nesting, the Piling Pot may provide an elegant solution to a common problem.

Consumers may enjoy filling the Piling Pots with any number of flowers or plants, creating arrangements that compliment the seascape or season. For instance, during the summer months, one may fill the Piling Pots with an abundance of colorful and fragrant flowers, while bright red poinsettias may prove ideal for the winter holiday season. Others may prefer to fill the Piling Pots with bountiful plants, decorative sea grass or other greenery. The Piling Pots may also be utilized for planting herbs and small vegetables, enabling waterfront inhabitants to enjoy the benefits of a fresh garden, even if they don't have the available land for planting one. Easily installed and durably constructed, the Piling Pot may withstand years of continued use, with ease.

The Piling Pot is a cleverly conceived product invention which may provide those who live in waterfront homes a practical way in which to prevent birds from perching on waterfront pilings. A fully functioning flower pot which is easily mounted to the top of a piling, this unique product invention may offer a simple means of preventing bird's infiltrations, while simultaneously enhancing the beauty of the waterfront. Affordably priced, the Piling Pot may be well received by any consumer who lives by the water.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A flower pot device designed to fit on top of a piling, comprising heavy duty and weather resistant plastic material, configured in an open, cylindrical shaped receptacle with the base of the unit measuring slightly smaller in diameter than the open mouth of the pot.

2. The flower pot device of claim 1 The Piling Pot may measure approximately 12 inches in depth, with pots featuring a diameter of 8 inches and 10 inches also offered in the line.

3. The flower pot device of claim 1 further comprising a circular shaped drainage hole may be centrally positioned on the base of the pot.

4. The flower pot device of claim 1 further comprising a cylindrical shaped sleeve designed to be mounted directly to the bulkhead as well as serving as a base tray for the flower pot itself

5. The flower pot device of claim 4 wherein the sleeve is secured to the top of the piling via two threaded screws driven through the center of the unit.

6. The flower pot device of claim 4 wherein the top of this sleeve culminates in an overflow tray for the flower pot, with a threaded fitting running the perimeter of the interior of the tray and corresponding to a threaded fitting located on the base of the flower pot.

7. The flower pot device of claim 1 further comprising solar powered lights incorporated into its design which are automatically activated during the evening hours.

8. The flower pot device of claim 2 wherein the pot may be produced in a range of vibrant colors and patterns, as well as natural bisque or neutral hues.

9. The flower pot device of claim 2, further comprising a decorative to sleeve to be applied to the outside of the pot wherein the decorative sleeve features different colors, textures and designs seasonal colors, or holiday decorations.
